(19) United States
(12) Patent Application Publication
(10) Pub. No.: US 2002/0043580 A1
(43) Pub. Date: Apr. 18, 2002

(54) Mill

(76) Inventor: Shigeo Yanase, Kisarazu City (JP)

Correspondence Address: CISLO & THOMAS, LLP, 233 WILSHIRE BLVD, SUITE 900, SANTA MONICA, CA, 90401-1211, US

(21) Appl. No.: 09/727,970

(22) Filed: Nov. 30, 2000

(30) Foreign Application Priority Data
Aug. 31, 2000 (JP) 2000-263075

(51) Int. Cl. B02C 17/02

(52) U.S. Cl. 241/85; 241/172

(57) ABSTRACT

This invention provides the mill wherein soft stones in mountain sand or mortal which attaches to debris surface of concrete wastes can be selective removed certainly without excessive pulverization of the other components and recycled aggregates that can be used as concrete aggregates can be recovered from these raw materials.

The mill is comprised by a hollow rotator which includes plural apertures functioning as both inlet and outlet of articles, and rotates with taking the articles inside thereof and plural loading members which are loaded inside of the hollow rotator, mills the articles by a motion of the loading members caused by rotation of the hollow rotator, wherein a center shaft passing through inside thereof and rotating in the opposite direction to the hollow rotator is provided in the hollow rotator, and plural cylindrical rods are provided parallel to the center shaft at the surface of the center shaft.

### FIELD OF THE INVENTION

The present invention relates to a mill, and its object is to provide the mill wherein recycled sand of quality that can be used as concrete aggregates are recovered from raw materials comprising mountain sand or concrete wastes.

### BACKGROUND ART

Hitherto, the sand gathered from river was used as raw materials of concrete aggregates in Japan. However, as a result of gathering sand in bulk for a long time, resource of river sand is on its way to becoming exhausted, and in recent years, mountain sand or sea sand is getting to be often used as a substitution of river sand.

Especially on Kanto area in Japan, mountain sand is often used as a substitution of river sand, but a large amount of soft stones such as clay clump or clod are included in mountain sand. Because the soft stones are included in the sand, specific gravity and/or coefficient of water absorption are deteriorated, so there is a problem that it is difficult to use the sand as concrete aggregates.

Thereupon, hitherto, crushing process of soft stones in sand is often carried out using a rod mill, a ball mill, etc. However, in the crushing process using these apparatus, the raw materials were prone to be excessively pulverized or insufficiently pulverized, and it was difficult to efficiently pulverize only the soft stones and to obtain aggregates of quality.

On the other hand, with demolition of architectures, concrete wastes are generated in bulk. Such wastes were hitherto used to reclaim the foreshore, but such processing method draws criticism in view of resource conservation or environmental protection in recent years.

Thereupon, a method for obtaining the recycled aggregates in consequence of crushing the concrete wastes that are generated by demolition of architectures is on the way to be developed. However, since mortar is attached to a surface of recycled aggregates which are obtained by crushing concrete aggregates, and coefficient of water absorption is high and specific gravity is small, additionally value of stability test is high; therefore, there was a problem that it is difficult to satisfy JIS standard for concrete aggregates (crushed sand).

In Japanese Patent No. 2863158, the present applicant previously proposed the pulverizer wherein, at outer peripheral surface of a hollow rotator having plural loading members (pulverization medium) inside thereof, plural apertures communicating with inside thereof and functioning as both inlet and outlet of articles to be pulverized and pulverized articles are disposed.

This pulverizer related to the present applicant's proposition is superior in that the pulverizing processing efficiency is higher as compared with the conventional rod mill or ball mill; however, the pulverization of raw material is carried out by a motion of the loading members, so that there is a week point what excessive pulverization is prone to be generated by that impact, and selective removing of just soft stones in mountain sand or mortar which attaches to debris surface of concrete wastes was difficult.

The present invention has been accomplished in view of the above circumstances, and the invention provides the mill wherein soft stones in mountain sand or mortal which attaches to debris surface of concrete wastes can be selective removed certainly without excessive pulverization of the other components and recycled aggregates that can be used as concrete aggregates can be recovered from these raw materials.

### BRIEF SUMMARY OF THE INVENTION

The invention relates to Claim 1 is the mill comprising a hollow rotator which includes plural apertures functioning as both inlet and outlet of articles to be milled and milled articles, and rotates with taking the articles to be milled inside thereof, and plural loading members which are loaded inside of the hollow rotator, mills the articles to be milled by a motion of the loading members caused by rotation of the hollow rotator, wherein a center shaft passing through inside thereof and rotating in the opposite direction to the hollow rotator is provided in the hollow rotator, and plural cylindrical rods are provided parallel to the center shaft at the surface of the center shaft.

The invention relates to Claim 2 is the mill as set forth in claim 1, wherein volume of loading members which is occupied in inner space volume of said hollow rotator is from 50 to 90%.

The invention that relates to Claims 3 and 4 is the mill as set forth in claims 1 or 2, wherein the number of said rods are from 4 to 20.

The invention relates to Claims 5 to 7 is the mill as set forth in any one of claims 1 to 3, wherein said rod is a hollow cylindrical shape, plural loading members are loaded inside thereof, and plural apertures which pass through inside thereof are provided at the surface thereof.

### DESCRIPTION OF THE DRAWINGS

FIG. 1 is an outer view showing the mill related to the present invention;

FIG. 2 is a cross section view along a line II-II in FIG. 1;

FIG. 3 is a cross section view along a line III-III in FIG.1;

FIG. 4 is an outer view showing another embodiment of the cylindrical rods using in the mill related to the present invention;

FIG. 5 is a cross section view along a line V-V in FIG. 4;

FIG. 6 is a cross section view along a line VI-VI in FIG. 4;

### DETAILED DESCRIPTION OF THE INVENTION

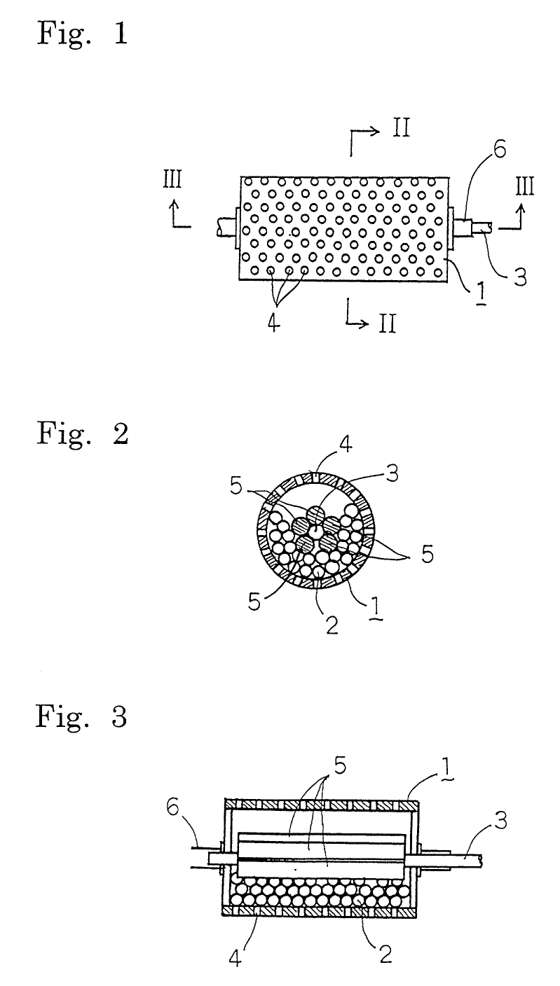

Embodiments of a mill related to the present invention will be explained based on the drawings. FIG. 1 is an outer view showing the mill related to the present invention, FIG. 2 is a cross section view along a line II-II in FIG. 1, and FIG. 3 is a cross section view along a line III-III in FIG. 1;

The mill related to the present invention has, as main composition; a hollow rotator (1) taking the articles to be milled inside thereof and rotating, plural loading members (2) loaded inside of the hollow rotator (1), a center shaft passing through inside of the hollow rotator (1), and plural cylindrical rods (5) mounting on the surface of the center shaft (5).

The hollow rotator (1) is a cylindrical shape and has plural apertures (4) which communicate with the inside at outer peripheral surface thereof, and plural loading members (2) are loaded inside thereof. Then milled articles are discharged out from the apertures (4) after articles to be milled are introduced from the apertures (4) to the inside of the hollow rotator (1) and are milled with a motion of the loading members (2) caused by the rotation of the hollow rotator (1). Further, the composition not illustrated wherein a casing is provided as if surrounding the outside of the hollow rotator (1) and articles to be milled are thrown into the casing is preferably adapted.

Although rods are used as the loading members (2) in the illustrated example, a kind of the loading members (2) is not restricted to this, and any other well-known shaped loading members (pulverization medium) such as balls may be used.

Also, the shape of the hollow rotator (1) is not restricted to the cylindrical shape as illustrated, and any kind of shape, such as quadrilateral cylindrical, hexagonal cylindrical, octagonal cylindrical, spherical, and ellipsoid shape, can be employed only if the hollow rotator (1) has the inside space capable of accommodating the loading members (2) and the articles to be milled therein, and the apertures (4) for flowing the articles to be milled through.

Further, the diameter and the number of the apertures (4) are not restricted particularly, and they may be set suitably in accordance with conditions such as the size of the hollow rotator (1), a kind of the articles to be milled, and the desired diameter of the milled articles.

Generally, the loading ratio of loading members in a mill such as a rod mill and a ball mill is about from 40 to 50%, but on the present invention, the volume (a loading ratio) of the loading members which is occupied in inner space volume of said hollow rotator is from 50 to 90%.

This reason is, caused by making the loading ratio of the loading members raises, preventing that the articles to be milled is suffered to pulverize excessively with the impact whereof the loading members(2) take a violent rising and falling motion inside of the hollow rotator (1), and milling the surface of articles to be milled with rubbing the loading members and the articles to be milled each other.

The rotating shaft (6) of the hollow rotator (1) is formed cylindrically; a center shaft (3) is inserted through the rotating shaft (6). The rotating shaft (6) and the center shaft (3) are comprised as they rotate in the opposite direction each other. Although, in the present invention, ordinarily, driving systems (a motor and the like) of both the center shaft (3) and the rotating shaft (6) are provided separately, a composition as they rotate in the opposite direction each other with using same driving system may be possible.

In the mill related to the present invention, by providing the center shaft (3) which rotate in the opposite direction to the rotating shaft (6) of the hollow rotator (1), the rotation of the loading members are uniformed and the loading members can be made to operate efficiently, the articles to be milled in the hollow rotator is disentangled moderately without stacking, and a flow of the articles to be milled is held in the hollow rotator and a moderate residence time will be able to be earned.

Further, at the surface of the center shaft (3), plural cylindrical rods (5) are provided parallel to the center shaft (3), with this means, the milling action is carried out at not only the space between the loading members (2) and articles to be milled but also the space between the cylindrical rods (5) and articles to be milled, and this makes that the milling efficiency can be remarkably raised.

Although, there is a pulvelizer having a center shaft whereof many projections are disposed at a surface thereof hitherto, the disposed projections as usual are for a role of partitions to carry out multistage pulverization, a stirring purpose, or pulverizing purpose, and can not act a role raising a milling action as the cylindrical rods (5) of the present invention, therefore the objects and the action efficiencies were completely different.

The number of the cylindrical rods (5) is from 4 to 20, preferably from 5 to 12. The reasons of this are because: if the number of the cylindrical rod (5) is less than 4, the center shaft (3) is hard to rotate because the loading members (2) get into between the cylindrical rods (5); on the other hand, if numbers mounting on the surface of the center shaft are made more, the diameter of cylindrical rod (5) becomes small, so that said disentangled action and a milling action become to be not shown sufficiently; and both of these cases are not preferable.

Furthermore, if the composition wherein from 5 to 12 cylindrical rods (5) are mounted is taken, said problems are not easy to happened very much, so that it is preferable.

Moreover, the center shaft (3) and the cylindrical rods (5) may be formed separately then be integrated with a fixing means, but they may be formed in one member beforehand.

The length of the cylindrical rod (5) is set about a little shorter than the length of the hollow rotator (1).

The material of the cylindrical rod (5) is same as the material of the loading members (2) preferably; iron is used suitably to be concrete.

In the mill related to the present invention, with using of the loading members (2) and the cylindrical rod (5), the surfaces thereof are getting to be abraded slowly, so that the use may be continue with replacing to new one when the abrasion rate is more than a given level.

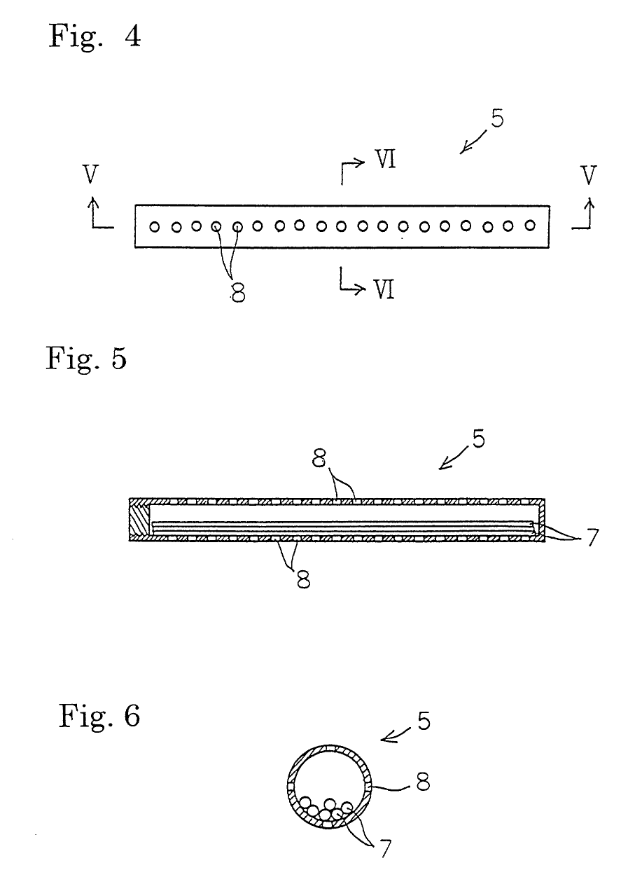

The mill related to the present invention, a solid as shown in FIG. 2 may be used for the cylindrical rod (5), also a hollow rod as shown in FIGS. 4 to 6 may be used.

Plural loading members (7) are loaded inside of the cylindrical rod (5) shaped hollow cylinder, and plural apertures (8) penetrating to the inside thereof are disposed at the surface thereof. Although, in the illustrated example, rods are used as the loading members (7), a kind of the loading members (7) in the present invention is not restricted to this, and any other well-known shaped loading members such as balls may be used.

When said cylindrical rod (5) shaped hollow cylinder is used in the present invention, the articles to be milled are taken from apertures (8) of the cylindrical rod (5) into the inside thereof, and are also gotten a rubbing action between loading members (7) and the cylindrical rod (5), so that a milling efficiency will be superior.

Embodiment

The effect of the present invention will be described more clearly with showing experimental results using the mill related to the present invention. Note that the present invention is not restricted to the following embodiments.

(Prepare of Raw Materials)

The aggregates of that the particle diameter is from 0 to 40 mm, which had been obtained by crushing concrete rubbish, are passed through a vibration sieve, components form 0 to 10 mm were taken out, and these were used as raw materials.

(Embodiment 1)

For a mill, that of the shape as shown in FIG. 1 to 3 was used. The hollow rotator (1) had an inner diameter of φ580 mm, the center shaft had φ65 mm of an outer diameter, and five rods of φ80 mm of an outer diameter were used for the cylindrical rods (5). Further, for the loading members (2), iron balls of φ60 mm of an outer diameter were used, and the void ratio inside of the hollow rotator (1) was 20%.

The experiment was carried out in the wet treatment; with that said prepared raw materials were thrown inside of the hollow rotator (1), and the hollow rotator at 40 rpm and the center shaft at 83 rpm were rotated in the opposite direction each other for one hour continuously.

(Embodiment 2)

In the mill of Embodiment 1, the experiment was carried out with replacing the cylindrical rods (5) to the hollow rods shown in FIG. 4 and FIG. 5. the cylindrical rod (5) had φ80 mm of an outer diameter and φ60 mm of an inner diameter, and the rod of φ30 mm of an outer diameter were used for the loading members (7) mounting inside of the cylindrical rod (5). The void ratio inside of the hollow rotator (1) was 20%. Also, the other conditions are set as same as the Embodiment 1.

(Comparative Example)

In the mill of Embodiment 1, the experiment was carried out; with removing the center shaft (3) and the cylindrical rods (5), and the other conditions are set as same as the Embodiment 1.

On the raw materials treated with the experiment of the Embodiments and the Comparative example, the bone dry specific gravity, the coefficient of water adsorption, and the stability were measured according to JIS standard. The results are shown in Table 1

TABLE 1

| | | | Comparative |
|---|---|---|---|
| | Embodiment 1 | Embodiment 2 | Example |
| Bone Dry Specific | 2.60 | 2.51 | 2.52 |
| Gravity | | | |
| Coefficient of Water | 2.21 | 2.52 | 2.80 |
| Adsorption (%) | | | |
| Stability (%) | 2.10 | 2.10 | 6.40 |

As shown in Table 1, the milled articles which are obtained from both the Embodiments and the Comparative example were satisfied the quality standard (JIS A 5005) of concrete aggregates (crushed sand), which says that: the bone dry specific gravity is 2.5 or more, the coefficient of water adsorption is 3% or less, and the stability is 10% or less. However, the milled articles obtained with the Embodiments are superior on the coefficient of water adsorption, and the stability than the comparative example, particularly on the stability test, much superior result than the Comparative example's could be obtained.

As described above, the invention relates to Claim 1 is the mill comprising a hollow rotator which includes plural apertures functioning as both inlet and outlet of articles to be milled and milled articles, and rotates with taking the articles to be milled inside thereof and plural loading members which are loaded inside of the hollow rotator, mills the articles to be milled by a motion of the loading members caused by rotation of the hollow rotator, wherein a center shaft passing through inside thereof and rotating in the opposite direction to the hollow rotator is provided in the hollow rotator, and plural cylindrical rods are provided parallel to the center shaft at the surface of the center shaft. Therefore, the following effects can be obtained.

That is, because the center shaft rotating in the opposite direction to the rotating shaft of the hollow rotator is provided, the rotation of the loading members are uniformed and the loading members can be made to operate efficiently, the articles to be milled in the hollow rotator is disentangled moderately without stacking, and the flow of the articles to be milled is held in the hollow rotator and a moderate residence time will be able to be earned.

Further, because plural cylindrical rods are provided parallel to the center shaft at the surface of the center shaft, the milling action is carried out at not only the space between the loading members and articles to be milled but also the space between the cylindrical rods and articles to be milled, so the milling efficiency can be remarkably raised.

Consequently, impurities such as soft stones in mountain sand or mortar that attaches to debris surface of concrete wastes can be removed certainly, and recycled aggregates of quality can be recovered with a high recovery percentage.

The invention relates to Claim 2 is the mill as set forth in claim 1, wherein volume of loading members which is occupied in inner space volume of said hollow rotator is from 50 to 90%. Therefore, articles to be milled is not suffered to pulverize excessively with the impact whereof the loading members take a violent rising and falling motion inside of the hollow rotator, and the surface of articles to be milled is milled certainly with rubbing the loading members and the articles to be milled each other.

The invention that relates to Claims 3 and 4 is the mill as set forth in claims 1 or 2, wherein the number of said rods is from 4 to 20. Therefore, a disentangled action of the articles to be milled and a milling action can be shown sufficiently and certainly.

The invention that relates to Claims 5 to 7 is the mill as set forth in any one of claims 1 to 3, wherein said rod is a hollow cylindrical shape, plural loading members are loaded inside thereof, and plural apertures which pass through inside thereof are provided at the surface thereof. Therefore, the articles to be milled are taken from apertures of the cylindrical rod into the inside thereof and are also gotten a rubbing action between loading members and the cylindrical rod, so that a milling efficiency will be superior.

1. The mill comprising:
a hollow rotator which includes plural apertures functioning as both inlet and outlet of articles to be milled and milled articles, and rotates with taking the articles to be milled inside thereof; and
plural loading members which are loaded inside of the hollow rotator, mills the articles to be milled by a motion of the loading members caused by rotation of the hollow rotator, wherein a center shaft passing through inside thereof and rotating in the opposite direction to the hollow rotator is provided in the hollow rotator, and plural cylindrical rods are provided parallel to the center shaft at the surface of the center shaft.

2. The mill as set forth in claim 1, wherein volume of loading members which is occupied in inner space volume of said hollow rotator is from 50 to 90%.

3. The mill as set forth in claim 1, wherein the number of said rods are from 4 to 20.

4. The mill as set forth in claim 2, wherein the number of said rods are from 4 to 20.

5. The mill as set forth in claim 1, wherein said rod is a hollow cylindrical shape, plural loading members are loaded inside thereof, and plural apertures which pass through inside thereof are provided at the surface thereof.

6. The mill as set forth in claim 2, wherein said rod is a hollow cylindrical shape, plural loading members are loaded inside thereof, and plural apertures which pass through inside thereof are provided at the surface thereof.

7. The mill as set forth in claim 3, wherein said rod is a hollow cylindrical shape, plural loading members are loaded inside thereof, and plural apertures which pass through inside thereof are provided at the surface thereof.
